(19) United States
(12) Patent Application Publication
(10) Pub. No.: US 2026/0186800 A1
(43) Pub. Date: Jul. 2, 2026

(54) APPLICATION TAG DISPLAY CONTROL METHOD AND ELECTRONIC DEVICE

(71) Applicant: Lenovo (Beijing) Limited, Beijing (CN)

(72) Inventors: Bingyu HUANG, Beijing (CN); Binqiang MA, Beijing (CN)

(21) Appl. No.: 19/416,043

(22) Filed: Dec. 11, 2025

(30) Foreign Application Priority Data
Dec. 31, 2024 (CN) 202411997795.8

(51) Int. Cl. G06F 9/451; G06F 3/04817; G06F 3/0482; G06F 3/04847

(52) U.S. Cl. CPC G06F 9/451; G06F 3/04847; G06F 3/04817; G06F 3/0482

(57) ABSTRACT

An application tag display control method includes: obtaining a trigger operation for a first application tag, the trigger operation being configured to adjust the first application tag to a second state, the first application tag being at a first state on a display bar; determining whether the first application tag and a second application tag meet an adjustment condition, the second application tag being at a second state on the display bar, a length of an application tag at the second state being greater than a length of the application tag at the first state, wherein the adjustment condition being that a cursor position is different from a display position of the first application tag at the second state; and in response to the first application tag and the second application tag meeting the adjustment condition, adjusting display parameters of the first application tag at the second state.

### CROSS-REFERENCE TO RELATED APPLICATION(S)

This application claims priority to Chinese Patent Application No. 2024119977958 filed on Dec. 31, 2024, which is incorporated herein by reference in its entirety.

### FIELD OF THE TECHNOLOGY

The present disclosure relates to the field of computer technology, and in particular to a display control method and electronic device for an application tag.

### BACKGROUND

The taskbar displays application tags for launched applications, such as the settings tab and the settings tab, to facilitate switching between the applications. In addition to the application icon, the application tag may also include the application name and shortcut key.

When there are many application tags, the taskbar may collapse the application tags. A collapsed application tag retains the application icons but hides the rest of the content. When a user clicks on a collapsed application tag, it expands and collapses any previously expanded application tags.

However, because the expanded length of application tags may vary between applications, expanding one application tag and collapsing another may cause the application tag to move forward, potentially changing the application tag under the mouse cursor. In this case, the user needs to move the mouse cursor again to the expanded application tag, which may be quite complex.

### SUMMARY

In one aspect, the present disclosure provides an application tag display control method. The method includes: obtaining a trigger operation for a first application tag, the trigger operation being configured to adjust the first application tag to a second state, the first application tag being an application tag at a first state on a display bar, the display bar being configured to display application tags of at least one application; determining whether the first application tag and a second application tag meet an adjustment condition, the second application tag being an application tag at a second state on the display bar, a length of an application tag at the second state being greater than a length of the application tag at the first state, the adjustment condition being that a cursor position is different from a display position of the first application tag at the second state; and in response to the first application tag and the second application tag meeting the adjustment condition, adjusting display parameters of the first application tag at the second state.

In another aspect, the present disclosure provides an electronic device. The device includes: a memory storing computer program instructions; and a processor coupled to the memory and configured to execute the computer program instructions and perform: obtaining a trigger operation for a first application tag, the trigger operation being configured to adjust the first application tag to a second state, the first application tag being an application tag at a first state on a display bar, the display bar being configured to display application tags of at least one application; determining whether the first application tag and a second application tag meet an adjustment condition, the second application tag being an application tag at a second state on the display bar, a length of an application tag at the second state being greater than a length of the application tag at the first state, the adjustment condition being that a cursor position is different from a display position of the first application tag at the second state; and in response to the first application tag and the second application tag meeting the adjustment condition, adjusting display parameters of the first application tag at the second state.

In yet another aspect, the present disclosure provides a non-transitory computer-readable storage medium storing computer program instructions executable by at least one processor to perform: obtaining a trigger operation for a first application tag, the trigger operation being configured to adjust the first application tag to a second state, the first application tag being an application tag at a first state on a display bar, the display bar being configured to display application tags of at least one application; determining whether the first application tag and a second application tag meet an adjustment condition, the second application tag being an application tag at a second state on the display bar, a length of an application tag at the second state being greater than a length of the application tag at the first state, the adjustment condition being that a cursor position is different from a display position of the first application tag at the second state; and in response to the first application tag and the second application tag meeting the adjustment condition, adjusting display parameters of the first application tag at the second state.

### BRIEF DESCRIPTION OF THE DRAWINGS

To more clearly illustrate the technical solutions of the embodiments of the present disclosure, the following briefly describes the figures used in describing the embodiments. The figures described below represent only certain embodiments of the present disclosure, and persons skilled in the technical field may derive other figures based on these figures without inventive effort.

FIG. 1 is a flow chart of an application tag display control method provided in certain embodiments of the present disclosure;

FIG. 2 is a display bar output from a display screen in certain embodiments of the present disclosure;

FIG. 3 shows expanding and collapsing an application tag in certain embodiments of the present disclosure;

FIG. 4 shows two application tags being expanded and collapsed, respectively, in certain embodiments of the present disclosure;

FIG. 5 shows triggering the expansion of an application tag according to certain embodiments of the present disclosure;

FIG. 6 shows triggering the expansion of an application tag according to certain embodiments of the present disclosure;

FIG. 7 shows an application tag being left-aligned according to certain embodiments of the present disclosure;

FIG. 8 shows an application tag being top-aligned according to certain embodiments of the present disclosure;

FIG. 9 shows an application tag being expanded in a scenario where the application tag is left-aligned according to certain embodiments of the present disclosure;

FIG. 10 is a diagram illustrating how to adjust the length of an application tag in a scenario where the application tag is left-aligned, according to certain embodiments of the present disclosure;

FIG. 11 is a diagram illustrating how to adjust the length of an application tag in a scenario where the application tag is left-aligned, according to certain embodiments of the present disclosure;

FIG. 12 is a diagram illustrating how to adjust the length of an application tag in a scenario where the application tag is left-aligned, according to certain embodiments of the present disclosure;

FIG. 13 is a diagram illustrating how to adjust the length of an application tag in a scenario where the application tag is left-aligned, according to certain embodiments of the present disclosure;

FIG. 14 is a diagram illustrating how to adjust the position of an application tag in a scenario where the application tag is left-aligned, according to certain embodiments of the present disclosure;

FIG. 15 is a diagram illustrating how to adjust the length of an application tag in a scenario where the application tag is left-aligned, according to certain embodiments of the present disclosure;

FIG. 16 is a diagram of adjusting an application tag in the context of launching an application in certain embodiments of the present disclosure;

FIG. 17 is a diagram of adjusting an application tag in the context of closing an application in certain embodiments of the present disclosure;

FIG. 18 is a diagram of adjusting an application tag in the context of closing an application in certain embodiments of the present disclosure;

FIG. 19 is a diagram of a display bar and a target window in certain embodiments of the present disclosure;

FIG. 20 is a diagram of a target window in certain embodiments of the present disclosure;

FIG. 21 is a diagram of a target window in certain embodiments of the present disclosure;

FIG. 22 is a diagram of a display bar in certain embodiments of the present disclosure;

FIG. 23 is a schematic diagram of the structure of an application tag display control device provided in certain embodiments of the present disclosure;

FIG. 24 is a schematic diagram of the structure of an electronic device provided in certain embodiments of the present disclosure;

FIG. 25 is a diagram of a window label in a scrolling screen according to the present disclosure;

FIG. 26 is a diagram of a window tag in a scrolling screen according to the present disclosure; and

FIG. 27 is a diagram of defining a window tag in a scrolling screen according to the present disclosure.

### DETAILED DESCRIPTION

The following is combined with the drawings in certain embodiments of the present disclosure to describe the technical solutions in certain embodiments of the present disclosure. The embodiments described reflect only part of the embodiments of the present disclosure, not all of the embodiments. Based on certain embodiments in the present disclosure, other embodiments obtained by persons in the technical field without making creative efforts are within the scope of protection of the present disclosure.

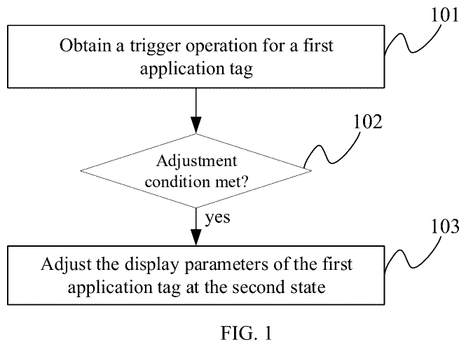

FIG. 1 shows a flowchart illustrating an implementation method of application tags display control, as provided in certain embodiments of the present disclosure. This method may be applied to electronic device with a display screen capable of displaying a display bar, such as laptops and tablets. As shown in FIG. 2, the display screen of the electronic device displays a display bar for displaying the application tag of at least one application, such as a chat application or an office application. An application tag may include one or more of tag contents including an application icon, at least one operation control, and an application name. Users may control the application tag by moving the mouse over it. The technical solution in certain embodiments reduces the complexity of user operations on the display bar.

The method in certain embodiments may include the following steps:
Step 101: Obtain a trigger operation for a first application tag.

The trigger operation is used to adjust the first application tag to a second state. The first application tag is the application tag at the first state on the display bar. In response to the trigger operation, the first application tag switches from the first state to the second state.

In addition to the first state, the application tag also has a second state. In certain embodiments, the length of the application tag at the second state is greater than the length at the first state. The length of the first application tag at the second state is greater than the length at the first state.

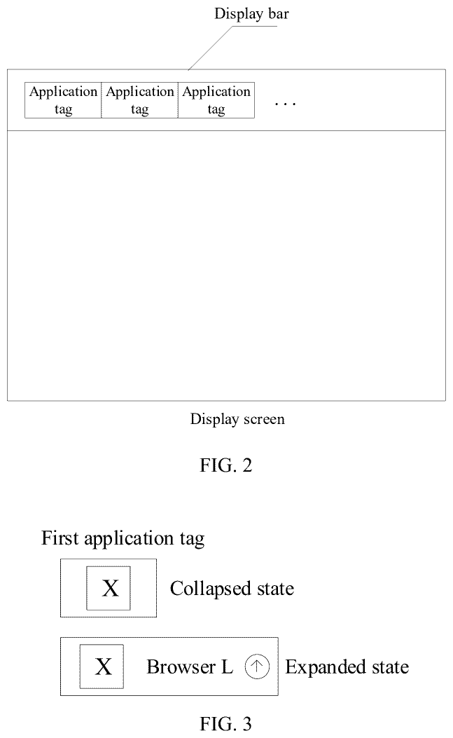

In certain embodiments, the second state may be understood as the expanded state of the application tag, and the first state may be understood as the collapsed state of the application tag. A collapsed application tag contains only the application icon, or only a portion of the application name, or an abbreviation of the application name. An expanded application tag contains not only the application icon but also the full application name. For example, as shown in FIG. 3, the first application tag may be a browser application tag. At the collapsed state, the first application tag contains only the browser icon X. At the expanded state, the first application tag contains not only the browser icon X but also the browser's sharing controls and the browser's name “Browser L.” Therefore, the length of the application tag at the expanded state is greater than the length at the collapsed state.
Step 102: Determine whether the first application tag and the second application tag meet the adjustment condition. In response to the first application tag and the second application tag meeting the adjustment condition, execute step 103.

The second application tag is an application tag at the second state on the display bar. That is, before receiving the trigger operation on the first application tag, the second application tag is at the second state, and the length of the second application tag at the second state is greater than the length of the second application tag at the first state.

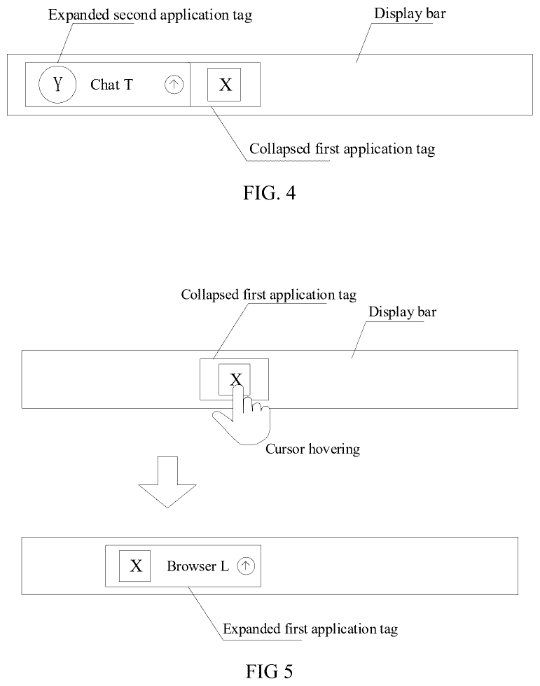

For example, as shown in FIG. 4, the first application tag may be a browser application tag, and the second application tag may be a chat application tag. The first application tag is at a collapsed state, containing only the browser icon X. The second application tag is at an expanded state, containing not only the chat application icon Y but also the chat application's sharing controls (for example, arrow icons) and the chat application's name, “Chat T.”

The adjustment condition may be that the cursor's position is different from the display position of the first application tag at the second state. In other words, the adjustment condition is met when the cursor is not in the display area of the first application tag at the second state.

The trigger operation on the first application tag causes the first application tag to enter the second state, indicating that further processing is required on the first application tag, such as clicking an operation control within the application tag. At this point, when the cursor is not within the display area where the first application tag at the second state is positioned, the user may move the cursor to the display area where the first application tag at the second state is positioned. Therefore, certain embodiments determine whether the adjustment condition is met. If so, the adjustment operation is performed, for example, step 103. If the adjustment condition is not met, the current process ends and step 101 is executed again.
Step 103: Adjust the display parameters of the first application tag at the second state.

In certain embodiments, the purpose of adjusting the display parameters is to align the cursor position with the display position of the first application tag at the second state. This allows the user to stay in the display area of the first application tag at the second state without having to move the cursor.

As may be seen from the above technical solution, in an application tag display control method provided in certain embodiments of the present disclosure, upon receiving a trigger operation for a first application tag at a first state, the method first determines whether an adjustment condition is met between the first application tag and a second application tag at a second state. When the adjustment condition is met, that is, when adjusting the first application tag to the second state causes the cursor position to differ from the display position of the first application tag at the second state, the present disclosure may adjust the display parameters of the first application tag at the second state so that the cursor position no longer differs from the display position of the first application tag at the second state. In other words, the cursor position aligns with the display position of the first application tag at the second state. Therefore, the technical solution of the present disclosure eliminates the need for the user to move the cursor again to the first application tag at the second state, thereby reducing user operation complexity and improving the user experience.

In one implementation, the trigger operation may be: hovering a cursor over the display area where the first application tag is positioned.

For example, as shown in FIG. 5, hovering a cursor over the first application tag at the first state triggers the first application tag to be adjusted to the second state.

In another implementation, the trigger operation may be: a trigger signal obtained based on the cursor's position in the display area where the first application tag is positioned.

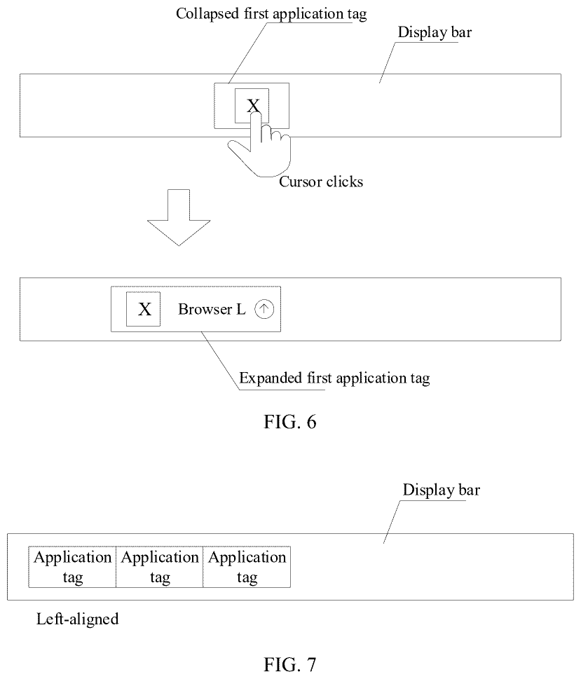

For example, as shown in FIG. 6, the cursor is moved to the display area where the first application tag is positioned, and the cursor clicks the display area where the first application tag is positioned, triggering the first application tag to be adjusted to the second state.

In one implementation, the adjustment condition may be: the first application tag is positioned farther from the tag display start point of the display bar than the second application tag, and the difference between the first length and the second length is greater than or equal to a first threshold.

The first length is the total length of the first application tag at the first state and the second application tag at the second state. The second length is the total length of the first application tag at the second state and the second application tag at the first state.

In certain embodiment, the tag display start point of a display bar may be either the left or right endpoint of the display bar. For example, as shown in FIG. 7, the tag display start point is the left endpoint of the display bar, and the application tag in the display bar is left-aligned.

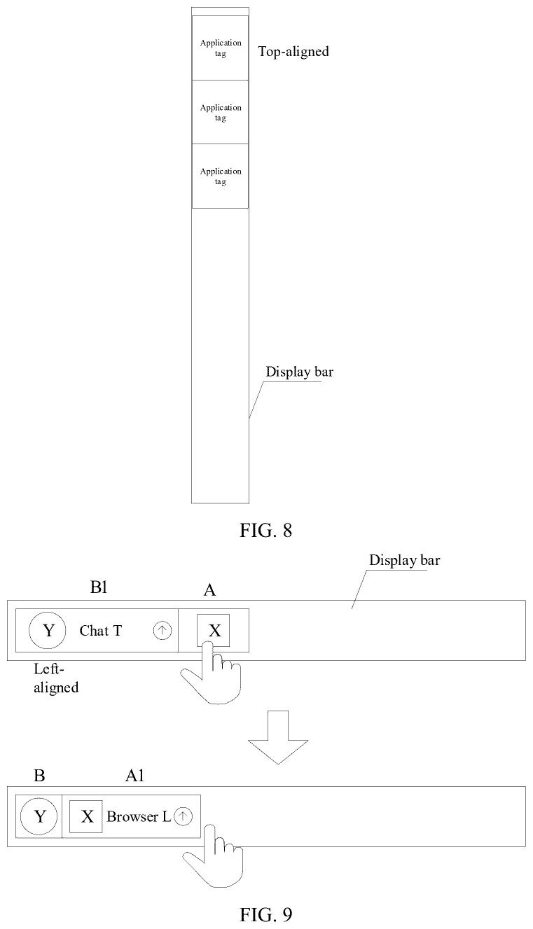

In certain embodiments, the tag display start point of a display bar may be either the top or bottom endpoint of the display bar. As shown in FIG. 8, the tag display start point is the top endpoint of the display bar, and the application tag in the display bar is top-aligned.

When a first application tag switches from its first state to its second state, its length increases. Meanwhile, when a second application tag switches from its second state to its first state, its length decreases. For example, in a scenario where the application tags in the display bar are left-aligned, when a user triggers the first application tag, the cursor position differs from the display position of the first application tag at the second state. This is because the second application tag is further to the left of the first application tag, and the total length of the first and second application tags decreases before and after the state switching. In other words, the difference between the first length and the second length is greater than or equal to a first threshold, where the first threshold is related to the cursor position.

For example, as shown in FIG. 9, using the scenario where the application tags in the display bar are left-aligned, the length of the browser application tag at the collapsed state is A, the length of the browser application tag at the expanded state is A1, the length of the chat application tag at the expanded state is B1, and the length of the chat application tag at the collapsed state is B. Because the chat application tag is further to the left of the browser application tag, when the user hovers the cursor over the browser application tag, because the total length of A plus B1 is greater than the total length of A1 plus B, the difference exceeds the distance between the cursor position and the rightmost position of the collapsed browser application tag (for example, the first threshold). Consequently, after expanding the browser application tag and collapsing the chat application tag, the cursor position is no longer over the expanded browser application tag, indicating that the adjustment condition is met.

For example, taking the scenario of application tags top-aligned in the display bar as an example, the length of the browser's application tag at the collapsed state is A, the length of the browser's application tag at the expanded state is A1, the length of the chat application's application tag at the expanded state is B1, and the length of the chat application's application tag at the collapsed state is B. Because the chat application's application tag is higher than the browser's application tag, when the user hovers the cursor over the browser's application tag, the difference between the total length of A plus B1 and the total length of A1 plus B exceeds the distance between the cursor position and the bottommost position of the collapsed browser's application tag (for example, the first threshold). As a result, after expanding the browser's application tag and collapsing the chat application's application tag, the cursor position is no longer on the expanded browser's application tag, indicating that the adjustment condition is met.

Based on the above implementation, in one possible implementation, when adjusting the display parameters of the first application tag at the second state in step 103, the length of the first application tag at the second state may be increased.

The increase in the length of the first application tag at the second state is such that the cursor position aligns with the display position of the first application tag at the second state.

Using FIG. 9 as an example, in certain embodiments, A1 may be increased to A2. The increase in A2 relative to A1 is such that the total length of A2 plus B causes the browser's application tag to at least cover the cursor position, that is, the cursor at least hovers within the browser's display area where the application tag is positioned.

In an implementation, the amount by which the length of the first application tag at the second state increases may be determined based on the distance between the cursor position and the end position of the first application tag at the second state.

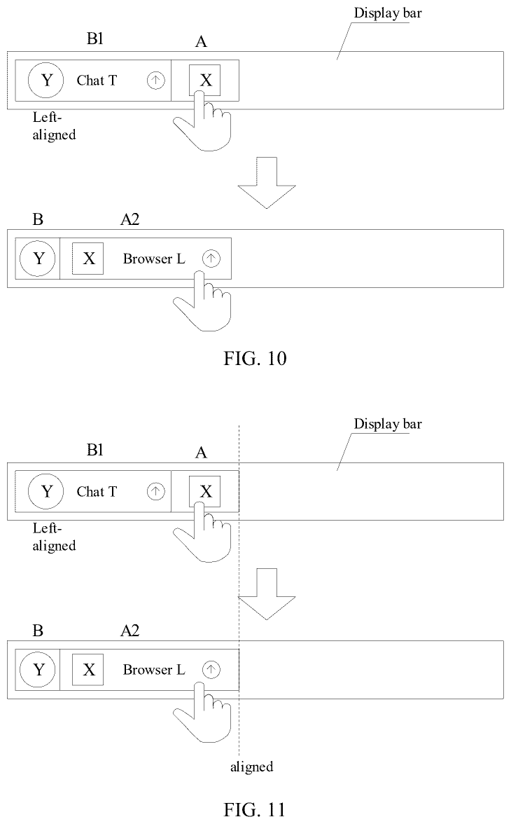

For example, as shown in FIG. 10, in certain embodiments, the browser's application tag (at the expanded state) may be increased from A1 to A2, with the increase in A2 relative to A1 being the length between the right side of the browser's application tag and the cursor position. This helps ensure that the cursor remains on the browser's application tag after the length of the expanded browser's application tag increases.

Furthermore, in an implementation, the amount by which the length of the first application tag at the second state increases may be the difference between the first length and the second length. In other words, in certain embodiments, the second length is adjusted to be equal to the first length, which helps ensure that the cursor remains within the display area of the first application tag.

For example, in certain embodiments, the browser's application tag may be expanded from A1 to A2. The increase in A2 relative to A1 is the target difference, which is the difference between the first length (the total length of A plus B1) and the second length (the total length of A1 plus B). In other words, the total length of A plus B1 is aligned with the total length of A2 plus B. As shown in FIG. 11, the end of the browser's application tag is aligned with the position before expansion. Thus, after increasing the length of the expanded browser's application tag, the cursor may remain on the browser's application tag.

In an implementation, at step 103, when adjusting the display parameters of the first application tag at the second state, the length of the second application tag at the first state may be increased.

The increase in the length of the second application tag at the first state is such that the cursor position aligns with the display position of the first application tag at the second state.

Using FIG. 9 as an example, in certain embodiments, B may be increased to B2. The increase in B2 relative to B helps ensure that the total length of B2 plus A1 causes the browser's application tag to at least cover the cursor's position. In other words, the cursor at least hovers within the browser's application tag display area.

In an implementation, the increase in the length of the second application tag at the first state may be determined based on the distance between the cursor's position and the end of the first application tag at the second state.

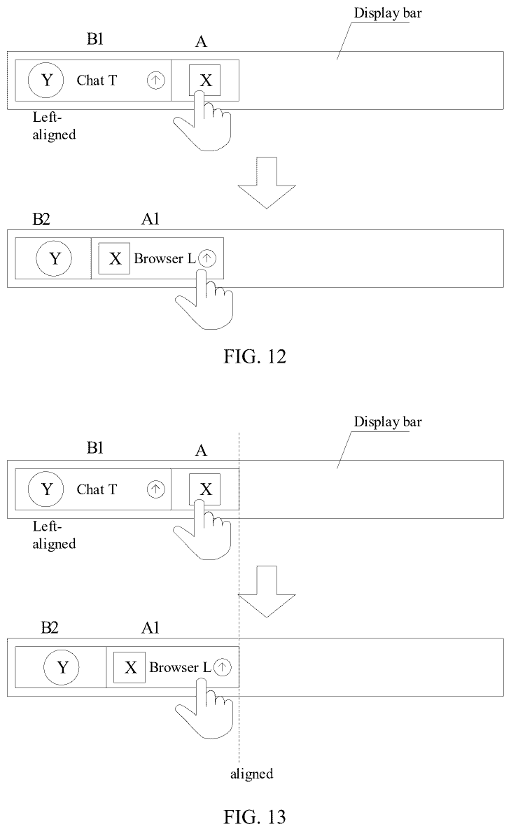

For example, as shown in FIG. 12, in certain embodiments, the chat application's application tag (at the collapsed state) may be increased from B to B2. The increase in B2 relative to B is the length between the right side of the browser's application tag and the cursor's position. Thus, after increasing the length of the collapsed chat application's application tag, the cursor may remain on the browser's application tag.

Furthermore, in an implementation, the increase in the length of the second application tag at the first state may be the difference between the first length and the second length. In other words, in certain embodiments, the second length is adjusted to be equal to the first length so that the cursor remains in the display area where the first application tag is positioned.

For example, in certain embodiments, the application tag of the collapsed chat application may be increased from B to B2, and the increase of B2 relative to B is the target difference, which is the difference between the first length (the total length of A plus B1) and the second length (the total length of A1 plus B). That is, the total length of A plus B1 is consistent with the total length of A1 plus B2. As shown in FIG. 13, the end position of the browser's application tag is aligned with the position before expansion. Therefore, after increasing the tag length of the application tag of the folded chat application, the cursor may still be on the application tag of the browser.

In an implementation, when adjusting the display parameters of the first application tag at the second state in step 103, the first application tag at the second state may be controlled to be displayed with the cursor position as the tag display start point.

In certain embodiments, when the application tags in the display bar are left-aligned, certain embodiments control the first application tag at the second state to be right-aligned with the cursor's position as the tag display start point. Other application tags to the left of the first application tag remain stationary, or right-aligned with the first application tag, other application tags to the right of the first application tag remain stationary. This prevents the cursor's position from misaligning with the first application tag at the second state due to changes in the total tag length caused by the expansion of the first application tag and the collapse of the second application tag. Thus, certain embodiments help ensure that the cursor's position consistently aligns with the first application tag at the second state, such that the cursor is positioned within the display area of the first application tag at the second state.

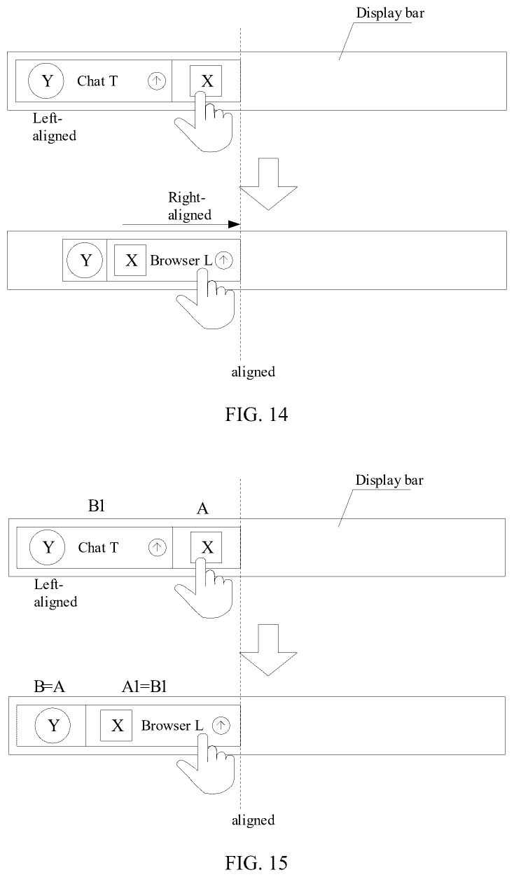

For example, as shown in FIG. 14, using the scenario where the application tags in the display bar are left-aligned, the expanded browser application tag and other application tags to the left are right-aligned with the cursor's position, while other application tags to the right of the expanded browser application tag remain stationary. At this point, after the browser application tag is expanded, the cursor is positioned within the display area of the expanded browser application tag.

In certain embodiments, in which the application tags in the display bar are right-aligned, certain embodiments control the first application tag at the second state to be left-aligned with the cursor's position as the tag display start point, while the other application tags to the right of the first application tag remain stationary, or left-aligned with the first application tag, the other application tags to the left of the first application tag remain stationary. This prevents the cursor's position from misaligning with the first application tag at the second state due to changes in the total tag length caused by the expansion of the first application tag and the collapse of the second application tag. Thus, certain embodiments help ensure that the cursor's position consistently aligns the first application tag at the second state, such that the cursor is positioned within the display area of the first application tag at the second state.

For example, in the scenario where the application tags in the display bar are right-aligned, the expanded browser application tag and the other application tags to the right are left-aligned with the cursor's position, while the other application tags to the left of the expanded browser application tag remain stationary. In this scenario, after the browser application tag is expanded, the cursor is positioned within the display area of the expanded browser application tag.

In the scenario where the application tags in the display bar are aligned, in certain embodiments, the first application tag at the second state is controlled to be bottom-aligned with the cursor's position as the tag display start point, while other application tags above the first application tag remain stationary, or bottom-aligned with the first application tag, other application tags below the first application tag remain stationary. In this way, the change in the total length of the labels caused by the expansion of the first application tag and the collapse of the second application tag does not cause the cursor's position to be mismatched with the first application tag at the second state. Therefore, in certain embodiments, the cursor's position may align with the first application tag at the second state, that is, the cursor is on the display area where the first application tag at the second state is positioned.

For example, taking the scenario where the application tags in the display bar are aligned, the application tag of the expanded browser and other application tags on the upper side are bottom-aligned with the cursor position as the start point, and the other application tags below the application tag of the expanded browser remain stationary. After the application tag of the browser is expanded, the cursor remains in the display area where the application tag of the expanded browser is positioned.

In certain embodiments, in which the application tags in the display bar are bottom-aligned, certain embodiments control the first application tag at the second state to be top-align with the cursor's position as the tag display start point, while other application tags below the first application tag remain stationary or top-aligned with the first application tag, other application tags above the first application tag remain stationary. This prevents the cursor's position from misaligning with the first application tag at the second state due to changes in the total tag length caused by the expansion of the first application tag and the collapse of the second application tag. Consequently, certain embodiments help ensure that the cursor's position consistently aligns with the first application tag at the second state, such that the cursor is positioned within the display area of the first application tag at the second state.

For example, in the scenario where the application tags in the display bar are bottom-aligned downward, the expanded browser application tag and other application tags below it are top-aligned with the cursor's position, while other application tags above the expanded browser application tag remain stationary. After the browser application tag is expanded, the cursor remains positioned within the display area of the expanded browser application tag.

Furthermore, based on the above implementation, in certain embodiments, the tag length of the first application tag at the second state may be simultaneously increased, or the tag length of the second application tag at the first state may be increased, as shown in FIGS. 10 to 13.

In one implementation, when adjusting the display parameters of the first application tag at the second state at step 103, the tag length of the first application tag at the second state may be adjusted to be consistent with the tag length of the second application tag before being adjusted to the first state; that is, the tag length of the first application tag at the second state may be adjusted to be consistent with the tag length of the second application tag at the second state; and the tag length of the second application tag at the first state may be adjusted to be consistent with the tag length of the first application tag before being adjusted to the second state; that is, the tag length of the second application tag at the first state may be adjusted to be consistent with the tag length of the first application tag at the first state.

For example, as shown in FIG. 15, certain embodiments adjust the expanded browser application tag from A1 to the same length as the expanded chat application tag, B1; and adjusts the collapsed chat application tag from B to the same length as the collapsed browser application tag, A. This way, after the browser application tag is expanded, the cursor is positioned in the display area where the expanded browser application tag is positioned.

In one implementation, certain embodiments may also adjust the third application tag to the second state and the fourth application tag to the first state in response to the addition of a third application tag to the display bar.

The fourth application tag is the application tag in the display bar that is at the second state before the third application tag is added to the display bar.

In an implementation, a user may launch an application to trigger the addition of that application tag, for example, the third application tag, to the display bar. When the third application tag is added to the display bar, the third application tag appears in the display bar at the second state, and the fourth application tag, previously at the second state, is adjusted to the first state.

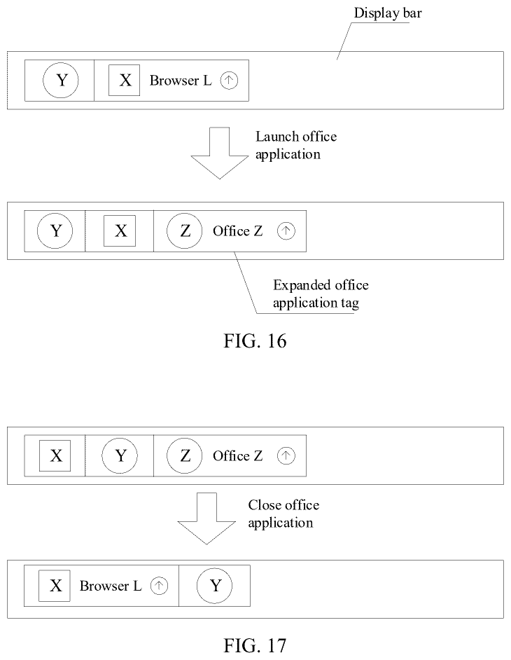

For example, as shown in FIG. 16, the display bar displays application tags for a browser and a chat application. When the user launches an office application, application tag Z for the office application appears in the display bar at an expanded state, containing the application name “Office Z” and sharing controls. The previously expanded browser and chat application tags are collapsed.

In an implementation, in response to the fifth application tag being deleted from the display bar, when the fifth application tag is at the second state before being deleted, certain embodiments may also adjust the sixth application tag to the second state.

In certain embodiments, the sixth application tag may be the application tag in the display bar that is at the second state before the fifth application tag is adjusted to the second state.

In an implementation, a user may close an application, triggering the deletion of the application tag (for example, the fifth application tag) from the display bar. This in turn adjusts the sixth application tag (currently at the first state) in the display bar, which is most recently at the second state, to the second state.

For example, as shown in FIG. 17, the display bar displays application tags for a browser, a chat application, and an office application. When a user closes the office application, the office application tag is deleted from the display bar. Because the office application tag is expanded before it is deleted, the browser application tag, which is expanded before the office application tag is expanded, is expanded after the office application tag is deleted.

In an embodiment, the sixth application tag may be an application tag whose display position in the display bar aligns with the display position of the fifth application tag.

The display position of the sixth application tag aligns with the display position of the fifth application tag, which may be understood as: the display position of the sixth application tag is adjacent to the display position of the fifth application tag, or is separated by a particular number of application tags, or the two display positions met a particular relationship. For example, the sixth application tag is the application tag that precedes or follows the fifth application tag in the display bar; another example, the sixth application tag is separated from the fifth application tag by one application tag; another example, the sixth application tag is the first application tag or the last application tag in the display bar where the fifth application tag is positioned.

In an implementation, a user may close an application, triggering the deletion of that application's application tag, for example, the fifth application tag, from the display bar, while resetting the application tag (currently at the first state) that precedes or follows the fifth application tag to the second state in the display bar.

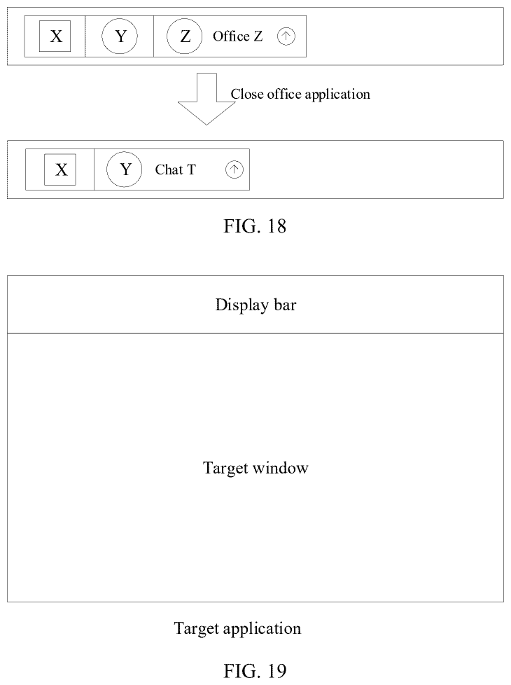

For example, as shown in FIG. 18, the display bar displays application tags for a browser, a chat application, and an office application. When the user closes the office application, the office application tag is deleted from the display bar. Because the office application tag is expanded before it is deleted, the chat application tag, closest to the office application tag, is expanded after the office application tag is deleted.

In an implementation, the application tag in the display bar may be the application tag corresponding to the application to which the sub-window displayed in the target window belongs.

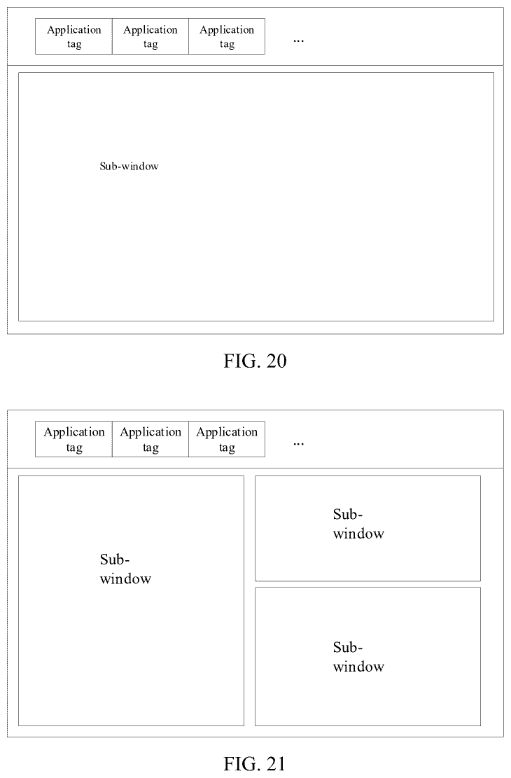

In certain embodiments, the target window may display at least one sub-window, each corresponding to an application, and the application tags corresponding to these applications are displayed in the display bar. For example, as shown in FIG. 20, the target window may display sub-windows for a browser, a chat application, and an office application, and the application tags for these three applications are displayed in the display bar.

Based on the above implementation, the display bar and the target window meet an alignment relationship. For example, when the display bar and the target window belong to the same target application, after the target application is launched, the target application has a corresponding running area, which is divided into the display bar area and the target window area, as shown in FIG. 19. For another example, when the target window belongs to the target application, after the target application is launched, the target application has a corresponding running area. The running area is the area where the target window is positioned, and the area where the display bar is positioned is associated with the running area, which is used to display the application tag corresponding to the application to which each sub-window in the target window belongs.

Furthermore, each sub-window is presented in the target window according to the target layout mode. For example, as shown in FIG. 20, each sub-window is displayed full screen in the target window, with only one sub-window positioned on top and the other sub-windows hidden. As another example, as shown in FIG. 21, each sub-window is tiled within the target window without blocking each other.

Based on the above implementation, certain embodiments may also respond to a click on a setting control in the display bar by displaying the first sub-window corresponding to the setting control in the target window and presenting the application tag corresponding to the first sub-window in the display bar.

The application to which the first sub-window belongs is used to set parameters for the application to which the target window belongs. In other words, the settings application corresponding to the settings control is used to set parameters for the target application.

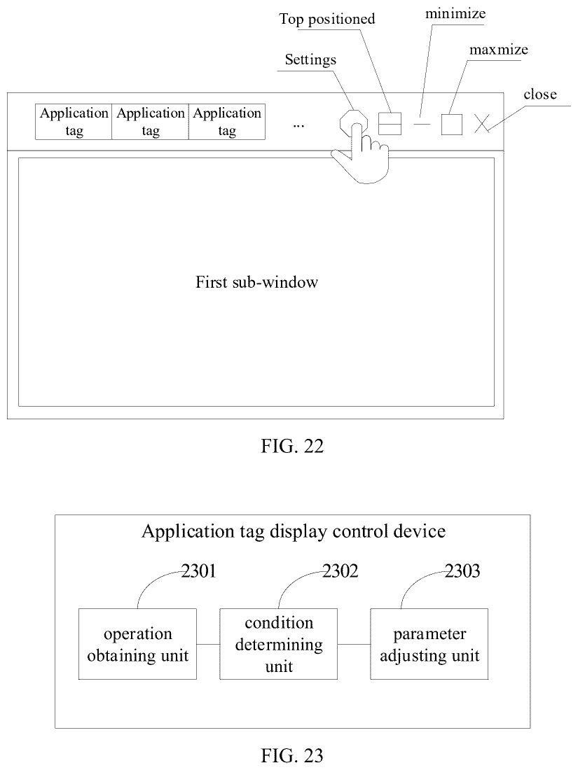

For example, as shown in FIG. 22, after the target application is launched, the target window and display bar appear in the running area. The display bar contains settings controls and other controls. The user may click the settings control to cause the first sub-window corresponding to the settings control to appear in the target window. The settings application tag corresponding to the settings sub-window launched by clicking the settings control appears in the display bar, and the settings application tag is expanded. The user may then set parameters for the target application in the settings sub-window.

Furthermore, the display bar also includes controls for pinning, minimizing, maximizing, and closing, as shown in FIG. 22. In certain embodiments, a click on the pinning control may control the target window to be pinned; a click on the minimizing control may control the target window to be minimized; a click on the maximizing control may control the target window to be resized to its configured maximum display size, such as half the current display screen; and a click on the closing control may control the target window to be closed.

FIG. 23 is a schematic diagram of an application tag display control device, provided in certain embodiments of the present disclosure. This device may be configured in an electronic device with a display screen for outputting a display bar, such as a laptop or tablet. The technical solution in certain embodiments is to reduce the complexity of user operations on the display bar.

The device in certain embodiments may include the following units:

An operation obtaining unit 2301, configured to obtain a trigger operation for a first application tag, the trigger operation being configured to adjust the first application tag to a second state; the first application tag being an application tag at the first state on a display bar; the display bar being configured to display application tags of at least one application;

A condition determining unit 2302, configured to determine whether the first application tag and a second application tag meet an adjustment condition; the second application tag being an application tag at the second state on the display bar; the length of the application tag at the second state being greater than the length of the application tag at the first state; and trigger a parameter adjusting unit 2303 in response to the first application tag and the second application tag meeting the adjustment condition.

The adjustment condition is: the cursor position is different from the display position of the first application tag at the second state;

Parameter adjusting unit 2303 is configured to adjust display parameters of the first application tag at the second state.

As may be seen from the above technical solution, in an application tag display control device provided in certain embodiments of the present disclosure, upon receiving a trigger operation for a first application tag at a first state, the device first determines whether an adjustment condition is met between the first application tag and a second application tag at a second state. When the adjustment condition is met, that is, when the first application tag is adjusted to the second state, the cursor position may be different from the display position of the first application tag at the second state. The present disclosure may then adjust the display parameters of the first application tag at the second state so that the cursor position no longer differs from the display position of the first application tag at the second state. In other words, the cursor position aligns with the display position of the first application tag at the second state. Consequently, the technical solution of the present disclosure eliminates the need for the user to move the cursor again to the first application tag at the second state, thereby reducing user operation complexity and improving the user experience.

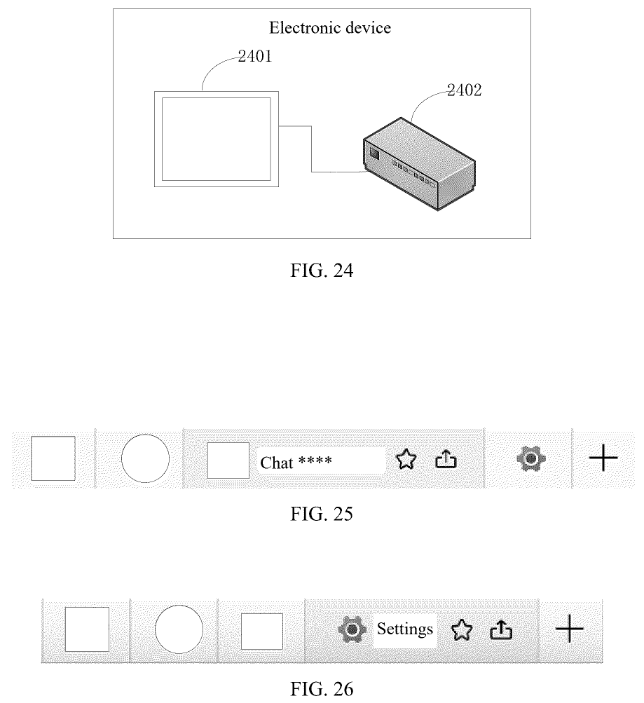

FIG. 24 shows a schematic diagram of an electronic device according to certain embodiments of the present disclosure. The electronic device may include the following:

Display screen 2401, configured to output a display bar, where the display bar is configured to display an application tag of at least one application;

Processor 2402 is configured to obtain a trigger operation for a first application tag, the trigger operation being configured to adjust the first application tag to a second state; the first application tag being the application tag at the first state on the display bar; determine whether the first application tag and a second application tag meet an adjustment condition; the second application tag being the application tag at the second state on the display bar; the length of the application tag at the second state being greater than the length of the application tag at the first state; and, in response to the first application tag and the second application tag meeting the adjustment condition, adjust display parameters of the first application tag at the second state.

The adjustment condition is that the position of the cursor is different from the display position of the first application tag at the second state.

As may be seen from the above technical solution, in an electronic device provided by certain embodiments of the present disclosure, upon receiving a trigger operation for a first application tag at a first state, the electronic device first determines whether an adjustment condition is met between the first application tag and a second application tag at a second state. When the adjustment condition is met, that is, when the first application tag is adjusted to the second state, the cursor position may be different from the display position of the first application tag at the second state. The present disclosure may then adjust the display parameters of the first application tag at the second state so that the cursor position no longer differs from the display position of the first application tag at the second state. In other words, the cursor position aligns with the display position of the first application tag at the second state. Consequently, the technical solution of the present disclosure eliminates the need for the user to move the cursor again to the first application tag at the second state, thereby reducing user operation complexity and improving the user experience.

For example, in an electronic device with a scrolling display, due to the limited horizontal width of the screen, the tag bar (referred to as the display bar above) for multi-application switching features automatically collapses. As shown in FIG. 25, the tag of the launched chat window (for example, the application tags) is expanded. When the user clicks the settings tab, the chat tag collapses and the settings tag expands.

As shown in FIG. 26, since the window tags are all left-aligned, when the user moves the mouse from left to right and clicks “settings,” the chat tag collapses and the settings tag expands, as shown in FIG. 26. However, because the settings window tag is relatively short, after the chat tag collapses and the settings tag expands, the user's mouse cursor hovers over the “+” tab instead of the settings tag. This forces the user to move the mouse left, which degrades the user experience.

In light of this, the present disclosure in certain embodiments dynamically calculates the size of the two window tags to help ensure that the mouse hover point stays within the expanded tag. The technical solution is as follows:

First, since the mouse hovering over the expanded tag area causes the tab to be left-aligned, a point worth consideration in the present disclosure is the collapsed and expanded sizes of the two tags.

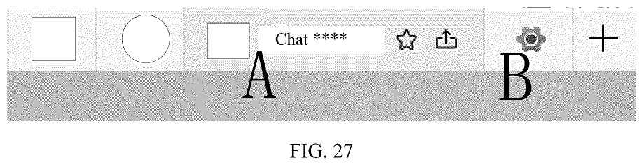

As shown in FIG. 27, the present disclosure defines the length of the chat window tag as A and A1; the length of the settings tag as B and B1. The collapsed lengths of the chat tag and settings tag are A and B, respectively, and the expanded lengths of the chat tag and settings tag are A1 and B1, respectively. Based on this, the present disclosure adjusts the sum of A plus B1 to be greater than or equal to the sum of A1 plus B, such that the changed tag is longer than the original tag.

In certain embodiments, the present disclosure may standardize the size of collapsed and expanded tags. That is, A and B are consistent, and A1 and B1 are consistent.

This helps ensure that the collapsed tag size is always larger than the width of the icon within the tag, preventing the icon from being obscured. Furthermore, when the text in the tag bar is smaller than the fixed available length of the expanded tag, it is centered. When the text in the tag bar is larger than the fixed available length, abbreviated text is displayed.

In certain embodiments, the present disclosure dynamically determines whether the total length of A plus B1 is less than the total length of A1 plus B, the length of B1 is dynamically increased to help ensure that the mouse cursor remains above the latter. The dynamically increased length may be just enough to make the two equal, at which point the text is centered.

In summary, after dynamic adjustment, the technical solution of the present disclosure helps ensure that the mouse is positioned above the expanded tag bar.

The present disclosure describes the various embodiments, with each embodiment focusing on its differences from other embodiments. References to the common and similar parts may be made between the various embodiments. Regarding the devices disclosed in the embodiments, since they correspond to the methods disclosed in the embodiments, reference to the description of the device may be made to the description of the method.

Persons skilled in the technical field appreciate that the units and steps described in the various embodiments may be implemented using electronic hardware, computer software, or a combination of both. To illustrate the interchangeability of hardware and software, the components and steps of each example have been described in terms of functionality in the above description. Whether these functions are implemented in hardware or software depends on the particular implementation and design of the technical solution. Persons skilled in the technical field may use different methods to implement the described functions, and such implementations may be considered within the scope of the present disclosure.

The steps of the methods described in conjunction with the embodiments disclosed herein may be implemented directly using hardware, a software module executed by a processor, or a combination of both. The software module may be positioned in random access memory (RAM), internal memory, read-only memory (ROM), electrically programmable ROM, electrically erasable programmable ROM, registers, a hard disk, a removable disk, a CD-ROM, or any other suitable form of storage medium.

The foregoing description of certain embodiments enables persons skilled in the technical field to implement or use the present disclosure. Modifications to these embodiments may be readily apparent to persons skilled in the technical field, and the general principles defined herein may be implemented in other embodiments without departing from the spirit or scope of the present disclosure. Therefore, the present disclosure is not limited to the embodiments shown herein but is to be accorded the widest scope consistent with the principles and novel features disclosed herein.

What is claimed is:

1. An application tag display control method, comprising:
obtaining a trigger operation for a first application tag, the trigger operation being configured to adjust the first application tag to a second state, the first application tag being an application tag at a first state on a display bar, the display bar being configured to display application tags of at least one application;
determining whether the first application tag and a second application tag meet an adjustment condition, the second application tag being an application tag at a second state on the display bar, a length of an application tag at the second state being greater than a length of the application tag at the first state, wherein the adjustment condition being that a cursor position is different from a display position of the first application tag at the second state; and
in response to the first application tag and the second application tag meeting the adjustment condition, adjusting display parameters of the first application tag at the second state.

2. The method of claim 1, wherein the trigger operation is:
that the cursor hovers over the display area where the first application tag is positioned; or
a trigger signal, obtained based on the cursor's position in the display area where the first application tag is positioned.

3. The method of claim 1, further comprising:
in response to adding a third application tag to the display bar, adjusting the third application tag to the second state and adjusting a fourth application tag to the first state, where the fourth application tag is an application tag in the display bar that is at the second state before the third application tag is added to the display bar.

4. The method of claim 1, further comprising:
in response to deleting a fifth application tag from the display bar, when the fifth application tag is at the second state before being deleted, adjusting a sixth application tag to the second state, wherein the sixth application tag is:
an application tag in the display bar that is at the second state before the fifth application tag is adjusted to the second state; or
an application tag in the display bar whose display position aligns with a display position of the fifth application tag.

5. The method of claim 1, wherein the application tag in the display bar is an application tag corresponding to an application to which a sub-window displayed in the target window belongs, wherein the display bar and the target window met an alignment relationship.

6. The method of claim 5, further comprising:
in response to a click operation on a setting control in the display bar, displaying a first sub-window corresponding to the setting control in the target window and presenting an application tag corresponding to the first sub-window in the display bar,
wherein the application to which the first sub-window belongs is used to configure parameters for the application to which the target window belongs.

7. The method of claim 1, wherein the adjustment condition includes that the first application tag is farther from a tag display start point of the display bar than the second application tag, and a difference between a first length and a second length is greater than or equal to a first threshold, and wherein the first length is a total length of the first application tag at the first state and the second application tag at the second state, and the second length is a total length of the first application tag at the second state and the second application tag at the first state.

8. The method of claim 7, wherein adjusting the display parameters of the first application tag at the second state includes one or both of:
increasing the tag length of the first application tag at the second state, wherein the increase in the tag length of the first application tag at the second state causes the cursor position to align with the display position of the first application tag at the second state; and
increasing the tag length of the second application tag at the first state, wherein the increase in the tag length of the second application tag at the first state causes the cursor position to align with the display position of the first application tag at the second state.

9. The method of claim 1, wherein adjusting the display parameters of the first application tag at the second state includes one or both of:
controlling the first application tag at the second state to be displayed with the cursor position as a tag display start point; and
adjusting the tag length of the first application tag at the second state to be consistent with the tag length of the second application tag before being adjusted to the first state, and adjusting the tag length of the second application tag at the first state to be consistent with the tag length of the first application tag before being adjusted to the second state.

10. An electronic device, comprising: a memory storing computer program instructions; and
a processor coupled to the memory and configured to execute the computer program instructions and perform:
obtaining a trigger operation for a first application tag, the trigger operation being configured to adjust the first application tag to a second state, the first application tag being an application tag at a first state on a display bar, the display bar being configured to display application tags of at least one application;
determining whether the first application tag and a second application tag meet an adjustment condition, the second application tag being an application tag at a second state on the display bar, a length of an application tag at the second state being greater than a length of the application tag at the first state, wherein the adjustment condition being that a cursor position is different from a display position of the first application tag at the second state; and
in response to the first application tag and the second application tag meeting the adjustment condition, adjusting display parameters of the first application tag at the second state.

11. The electronic device of claim 10, wherein the trigger operation is:
that the cursor hovers over the display area where the first application tag is positioned; or
a trigger signal, obtained based on the cursor's position in the display area where the first application tag is positioned.

12. The electronic device of claim 10, wherein the processor is further configured to perform:
in response to adding a third application tag to the display bar, adjusting the third application tag to the second state and adjusting a fourth application tag to the first state, where the fourth application tag is an application tag in the display bar that is at the second state before the third application tag is added to the display bar.

13. The electronic device of claim 10, wherein the processor is further configured to perform:
in response to deleting a fifth application tag from the display bar, when the fifth application tag is at the second state before being deleted, adjusting a sixth application tag to the second state, wherein the sixth application tag is:
an application tag in the display bar that is at the second state before the fifth application tag is adjusted to the second state; or
an application tag in the display bar whose display position aligns with a display position of the fifth application tag.

14. The electronic device of claim 10, wherein the application tag in the display bar is an application tag corresponding to an application to which a sub-window displayed in the target window belongs, wherein the display bar and the target window met an alignment relationship.

15. The electronic device of claim 14, wherein the processor is further configured to perform:
in response to a click operation on a setting control in the display bar, displaying a first sub-window corresponding to the setting control in the target window and presenting an application tag corresponding to the first sub-window in the display bar,
wherein the application to which the first sub-window belongs is used to configure parameters for the application to which the target window belongs.

16. The electronic device of claim 10, wherein the adjustment condition includes that the first application tag is farther from a tag display start point of the display bar than the second application tag, and a difference between a first length and a second length is greater than or equal to a first threshold, and wherein the first length is a total length of the first application tag at the first state and the second application tag at the second state, and the second length is a total length of the first application tag at the second state and the second application tag at the first state.

17. The electronic device of claim 16, wherein adjusting the display parameters of the first application tag at the second state includes one or both of:
increasing the tag length of the first application tag at the second state, wherein the increase in the tag length of the first application tag at the second state causes the cursor position to align with the display position of the first application tag at the second state; and
increasing the tag length of the second application tag at the first state, wherein the increase in the tag length of the second application tag at the first state causes the cursor position to align with the display position of the first application tag at the second state.

18. The electronic device of claim 10, wherein adjusting the display parameters of the first application tag at the second state includes one or both of:
controlling the first application tag at the second state to be displayed with the cursor position as a tag display start point; and
adjusting the tag length of the first application tag at the second state to be consistent with the tag length of the second application tag before being adjusted to the first state, and adjusting the tag length of the second application tag at the first state to be consistent with the tag length of the first application tag before being adjusted to the second state.

19. A non-transitory computer-readable storage medium storing computer program instructions executable by at least one processor to perform:
obtaining a trigger operation for a first application tag, the trigger operation being configured to adjust the first application tag to a second state, the first application tag being an application tag at a first state on a display bar, the display bar being configured to display application tags of at least one application;
determining whether the first application tag and a second application tag meet an adjustment condition, the second application tag being an application tag at a second state on the display bar, a length of an application tag at the second state being greater than a length of the application tag at the first state, wherein the adjustment condition being that a cursor position is different from a display position of the first application tag at the second state; and
in response to the first application tag and the second application tag meeting the adjustment condition, adjusting display parameters of the first application tag at the second state.

20. The non-transitory computer-readable storage medium of claim 19, wherein the trigger operation is:
that the cursor hovers over the display area where the first application tag is positioned; or
a trigger signal, obtained based on the cursor's position in the display area where the first application tag is positioned.
